(19) United States
(12) Patent Application Publication
(10) Pub. No.: US 2012/0154902 A1
(43) Pub. Date: Jun. 21, 2012

(54) Coherent Ultra-Short Ultraviolet or Extended Ultraviolet Pulse Generating Systems

(75) Inventors: Johan Boullet, Bordeaux (FR); Eric Constant, Talence (FR); Eric Cormier, Cestas (FR)

(73) Assignee: CENTRE NATIONAL DE LA RECHERCHE SCIENTIFIQUE - CNRS, Paris Cedex 16 (FR)

(21) Appl. No.: 13/146,133

(22) PCT Filed: Jan. 26, 2010
(86) PCT No.: PCT/EP2010/050853

§ 371 Date: Jan. 3, 2012

Related U.S. Application Data
(60) Provisional application No. 61/147,255, filed on Jan. 26, 2009.

(51) Int. Cl. G02F 1/355; G02F 1/35

(52) U.S. Cl. 359/328

(57) ABSTRACT

The present invention generally relates to coherent, ultra-short ultraviolet (UV) or extended ultraviolet (XUV) pulse generation, and more particularly, to a highly bright re-focusable source capable of producing, at an adjustable rate comprised between 50 kHz and a few megahertz, femtosecond long pulses, in the ultraviolet or extended ultraviolet range. It comprises: —a fiber laser device adapted to produce laser beam comprising pulses, —an harmonic generator device comprising an interaction medium. The harmonic generator device and the fiber laser device are coupled so that the laser beam hits the interaction medium with a power of at least 10 13 W/cm2, so as to generate said UV-XUV pulses.

### TECHNICAL FIELD OF THE INVENTION

The present invention generally relates to coherent ultra-short ultraviolet (UV) or extended ultraviolet (XUV) pulse generating systems, and more particularly, to a highly bright re-focusable source capable of producing, at an adjustable rate comprised between 50 kHz and a few megahertz, femtosecond long pulses, in the ultraviolet or extended ultraviolet range.

### RELATED ART

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

In the present description, XUV radiation should be understood as a radiation with a wavelength spanning sensitively from 10 nm to 350 nm.

When building an XUV radiation source, fiber-based laser systems are generally considered. Amongst this category of systems, only a subset of them is capable of producing XUV radiation comprising pulses at repetition rates higher than 100 kHz.

For example, one might consider using Synchrotron systems for this purpose, since they can produce XUV pulses at such high repetition rates. However, the XUV pulses produced by synchrotron systems are incoherent. Moreover, Synchrotron systems are particularly expensive.

One might also consider systems built around a femtosecond laser system coupled to a high order harmonic generation module in an external passive Fabry-Perot cavity. These systems are capable of producing coherent short XUV pulses at high repetition rates. Nevertheless, the external passive Fabry-Perot cavity needs to be locked, which implies the use of complex electronic devices. Moreover, extracting the XUV beam efficiently is particularly difficult.

Therefore, there is a need to overcome said deficiencies, and more particularly to provide a pulse generating systems capable of producing, at a rate comprised between 50 kHz and a few megahertz, femtosecond long coherent pulses, in the ultraviolet or extended ultraviolet range.

### SUMMARY OF THE INVENTION

To address these needs, a first aspect of the present invention relates to a system for generating UV-XUV coherent pulses, comprising:
a fiber laser device adapted to produce a laser beam comprising pulses;
an harmonic generator device comprising an interaction medium.

The harmonic generator device and the fiber laser device are coupled so that, the laser beam hits the interaction medium with a power of at least 10¹³ W·cm², so as to generate said UV-XUV pulses.

More particularly, the frequency of the pulses produced by the fiber laser device can be configurable to adjust the rate of production of UV-XUV coherent pulses from 50 kHz to a few MHz.

In an embodiment, said fiber laser device comprises means for chirp pulse amplification. In another embodiment, said fiber laser device comprises means for direct femtosecond amplification.

The interaction between the interaction medium and the laser beam generates, in particular, the XUV pulses at high order harmonic frequencies.

In an embodiment, the fiber laser device comprises rod-type fibres. In particular, the fiber laser device can comprise Yb-doped large mode area fibers, or Eb-doped large mode area fibers, or Tu-doped large mode area fibers.

The interaction medium may comprise gas, more particularly inert gas. The interaction medium may also comprise a liquid target and/or a solid target.

In an embodiment, the harmonic generator device may comprise means adapted to confine the gas and to guide the laser beam, so that the gas and the laser beam interact.

In another embodiment, the harmonic generator device comprises a cell comprising the gas in which an input hole and an output hole are drilled by the laser beam, so that the gas and the laser beam interact.

In another embodiment, the harmonic generator device may comprise a gas-filled hollow core fiber, arranged so that the gas and the laser beam interact.

The system may further comprise an XUV spectrophotometer coupled to receive the UV-XUV coherent pulses.

More particularly, the XUV pulse generator device produces pulses through high order harmonic generation during interaction between the intense laser infra red pulses and a gas.

The intense laser pulses are produced by a laser device based on amplification of ultrashort femtosecond (30 to 1000 fs) pulses in active fibers

The system according to the first aspect can produce very high order harmonic frequency at a rate comprised between 50 kHz and a few megahertz pulses, using directly a fiber laser. This result is notably obtained by the generation of high intensity pulses.

Therefore, the system according to the first aspect allows to combine the advantages of the high intensity fiber laser and the advantages of the generation of an XUV radiation with high order harmonic pulses. In particular, the system can produce a radiation comprised in a wide spectral range from UV to XUV. The radiation is coherent spatially and temporally. The radiation is re-focusable and with high brightness. The wavelengths of the radiation are ultra-short. Moreover, a very high XUV pulse rate of the radiation can be reached. The radiation can be synchronised with a short infra-red pulse, reaching thus a temporal resolution which can be in the range of a few nanoseconds to a few picoseconds.

The invention may aim the whole laser system including a harmonic generator device and a high repetition rate laser. The invention may aim also the harmonic generator device only, for applications which would not be limited to laser pumping, but also to any laser source providing for example low energy pulses. Moreover, the present invention aims also a method for generating XUV coherent pulses, wherein a harmonic generator device is used in combination with a fiber laser device as a driver of the said harmonic generator device.

According to another advantage of the invention, the combination of a harmonic generator device and the fiber laser device results in a very compact and simple system, compared to other high repetition rate systems such as synchrotron or laser injected fabry perot external cavities.

According to another advantage of the invention, the pulse rate is adjustable from 50 kHz to a few MHz. The system allows a synchronous use of different types of radiations, for example for micro-machining using a femto-laser (for example infrared and XUV radiations). The system is very simple to use compared to a Fabry-Perot cavity and offers all the advantages related to fiber amplification systems (average power higher than 10 W, stability, beam quality (e.g. a single mode), diode laser pumping, no cooling system needed, etc.).

Other advantages and features of the invention will become apparent on reading the detailed description given hereafter by way of an example.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic view of a coherent XUV pulse generating system;

FIG. 2 is a schematic view of the laser device;

FIG. 3 is a schematic view of the harmonic generator device coupled to the applicative device;

FIG. 4 is a schematic view of the applicative device comprising an XUV spectrometer and a beam transport.

### DESCRIPTION OF PREFERRED EMBODIMENTS

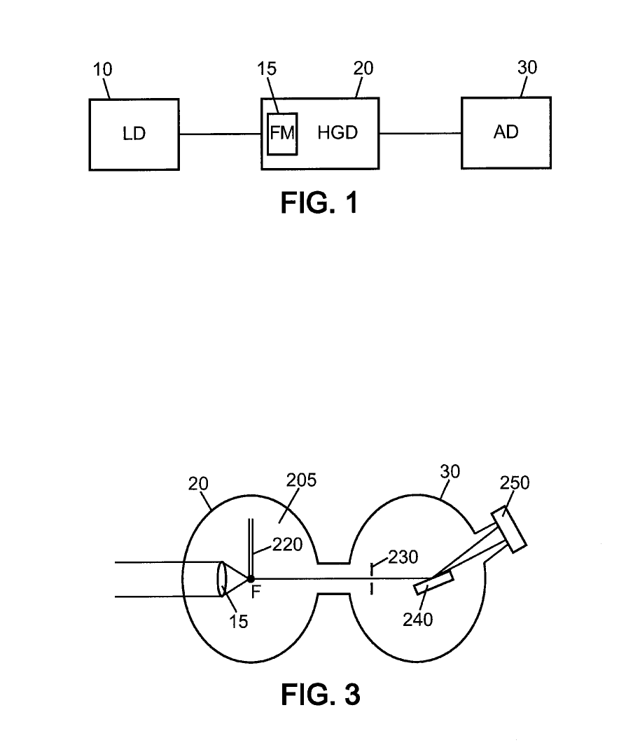

Referring now to FIG. 1, there is shown therein a schematic view of a coherent XUV pulse generating system, according to an embodiment. The system comprises a laser device 10, a harmonic generator device 20 and an applicative device 30. The system is capable of providing femtosecond or picosecond long XUV pulses, at a rate typically comprised between 50 kHz and a few megahertz. The laser device 10 is built around a fibre laser device, for example an ultra large core active fibre laser device. In particular, the fibres can be rod-type fibres, although any kind of ultra large mode area fiber might be used as long as the output remains single mode. The laser device may use Yb-doped large mode area fibers. The structure of such fibres is disclosed notably in the patent document US 2006/0176911. The laser device may also use Eb-doped large mode area fibers or Tu-doped large mode area fibers.

The laser device 10 is assembled to deliver a laser beam to an output. The output of the laser device 10 is coupled to focusing means 15, so as the laser beam goes through the focusing means and comes out focused. The focusing means 15 can be included in the harmonic generator device 20. The harmonic generator device 20 is disposed to receive the focused laser beam at the output of the focusing means 15. The harmonic generator device 20 allows generating, from the focused laser beam, an XUV radiation beam comprising high order harmonic pulses. To this end, the harmonic generator device 20 comprises a medium, playing the role of a target, hit by the focused laser beam. The laser device 10 is capable of providing a power of at least 10¹³ W˜cm² on the target of the harmonic generator device 20. The applicative device 30 is coupled to the harmonic generation device to receive the XUV radiation beam. The applicative device 30 is for example an application chamber, characterization means like a XUV spectrophotometer, shaping means, and/or transport means.

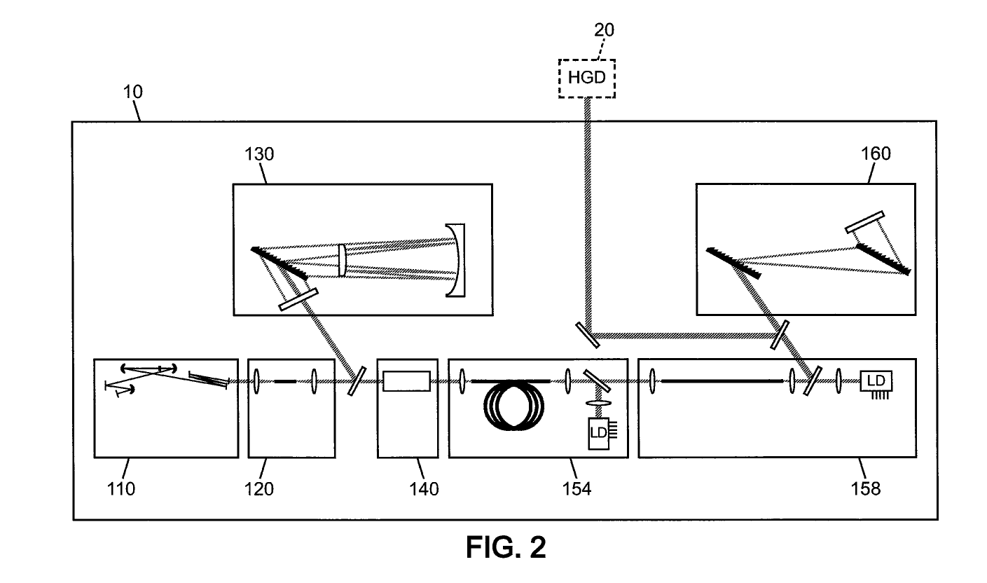

Referring now to FIG. 2, there is shown therein a schematic view of an embodiment of the laser device 10. The laser device 10 comprises an oscillator 110, a spectral broadening stage 120, a stretcher unit 130, a pulse selector 140, amplifiers 150, and a compressor unit 160. The output of the laser device 10 is coupled to the output of the compressor unit 160.

The oscillator 110 acts as a femtosecond seed laser source. For example, the oscillator 110 is a passively mode locked Yb:KGW laser using a semiconductor saturable absorber mirror (SESAM). Typically, the oscillator 110 is capable of producing, at a frequency of 10 MHz, 400 femtoseconds long pulses with an average power of 1.7 W. These pulses are Fourier-transform-limited, and possess a spectral width of 2.5 nm around the centre wavelength of 1030 nm.

The spectral broadening stage 120 is a self phase modulation induced spectral broadening stage, used to broaden the spectre and to shorten the duration of the pulses delivered by the oscillator 110. To achieve these goals, the spectral broadening stage 120 can comprise a self phase modulation in a passive 40 μm core diameter photonic crystal fibre. The fibre length, typically 5 cm, is chosen to obtain a flat spectrum up to 8 nm wide, measured full width at half maximum (FWHM).

The pulses at the output of the spectral broadening stage 120 are redirected to the stretcher unit 130. The stretcher unit 130 may be a transmission grating based Offner stretcher, with a grating having a density of 1740 lines per mm. The stretcher unit 130 allows increasing the duration of the pulses to 600 ps.

The pulse selector 140 is arranged to receive the pulses from the stretcher unit 130. The pulse selector 140 is used to adapt the pulse repetition rate, and in particular to reduce the pulse repetition rate so as it is comprised between 100 kHz to 1 MHz. At the output of the pulse selector 140, the average power of the pulses is in the range of the milliwatt level. The pulse selector 140 is, for example, an acousto-optical modulator, typically a quartz-based acousto-optical modulator. The amplifiers 150 are subdivided in a pre-amplifier 154 and a final amplifier 158. The pre-amplifier 154 is coupled to the output of the pulse selector 140. The pre-amplifier 154 permits to increase the average power of the pulses to the watt level before injection of said pulses in the final amplifier 158. The fibre pre-amplifier may comprise an air clad photonic crystal fibre. The length of said fibre is 1.5 m, and the diameter of its core is 40 μm. Said fibre has an inner cladding diameter of 170 μm which is pumped by a diode emitting at 976 nm. The final amplifier 158 may comprise an ultra-large mode area rod type photonic crystal fibre. The mode-field diameter is as large as 70 μm, corresponding to an effective mode-field area of 3850 μm². The large overlap between the pump wave and the doped core allow limiting the necessary fibre length to 1.2 m, the small signal pump-light absorption being 30 dB/m at 976 nm. The two micro-structures for signal and pump radiations are surrounded by a 1.5 mm fused-silica rod, which increases the heat dissipation capability of the fibre and reduces the propagation losses of the weakly guided amplified wave. The fibre ensures dual guiding of both the pump and amplified beam. The final amplifier 158 is capable of delivering a power independent diffraction limited beam (M2<1.25).

The stretched and amplified pulses at the output of the final amplifier 158 are routed to be recompressed to the compressor unit 160, for example a transmission grating based compressor with a grating having a density of 1740 lines per mm. For example, the gratings are used at the Littrow angle (64°) relatively to the pulses and present a diffraction efficiency of 85%, resulting in double pass compressor overall efficiency of about 52%. Considering a repetition rate of 1 MHz and an average power level of 56 W before compression, the average power level of the pulses after compression is sensitively 28 W. No thermo-optical or thermo-mechanical issues are observed up to this average power level. The output of the laser device 10 is coupled to an output of the compressor unit 160.

The laser device is highly compact and can deliver sub 300 fs pulses during less than 300 fs, with a pulse energy ranging from 100 μJ at a repetition rate of 100 kHz to 28 μJ at a repetition rate of 1 MHz.

Referring now to FIG. 3 there is shown therein a schematic view of an embodiment of the harmonic generator device 20 coupled to the applicative device 30. In this embodiment, the applicative means 30 corresponding to an XUV spectrometer. The harmonic generator device 20 comprises an interaction chamber with an internal cavity 205 in vacuum conditions. The pressure in the internal cavity 205 is preferably around 10⁻³ bar. The laser beam generated by the laser device 10 is received as an input of the harmonic generator device 20, and is directed to go through the focusing means 15. The laser beam is then focused to a point of focus F inside the internal cavity 205. For example, the focusing means 15 is a lens or a mirror with a focal length of approximately 100 mm. An interaction medium is continuously delivered in the internal cavity 205 to form a jet 220. For example, a capillary tube can be used to deliver an effusive gas, for example an inert gas such as argon, neon and/or krypton. The tip of the capillary tube is located in the direct vicinity of the point of focus F. The capillary diameter is in the range of 120 to 170 μM, preferably around 150 μm. Thus the effusive gas enters the internal cavity 205 to be used as target, where the laser beam is focused. The interaction between the laser beam and the atomic gas generates XUV radiation beam. The peak intensity of the laser beam, with an available pulse energy of 100 μJ, is 7.12·10¹³ W·cm⁻² at the point of focus F. In an embodiment, motorized translation stages are used to adjust precisely the position of tip of the capillary tube 220, in order to control the laser/gas interaction, in particular the point of contact.

In order to allow the interaction with gaz and the laser beam, other gas-laser interaction means can be used to increase the harmonic generation efficiency.

For example, an adequate gas-laser interaction means could be a mean for filling by capillarity the gas into the internal cavity 205, arranged to confine the gas and to guide the laser beam. Such a mean allows notably to increase the length of the period of the gas-laser interaction. Another adequate gas-laser interaction means could be a gas cell in which the input and output hole can even be directly drilled by the laser beam, for automatic alignment. Another adequate gas-laser interaction means could be a gas-filled hollow core fiber. These gas-laser interaction means are notably described in the article “High harmonic generation in a gas-filled hollow-core photonic”—Applied Physics B: Lasers and Optics—Springer Berlin/Heidelberg—ISSN 0946-2171 (Print) 1432-0649 (Online)—Volume 97, Number 2/octobre 2009—DOI 10.1007/s00340-009-3771-x—Pages 369-373—Subject Collection Physics and Astronomy <http://www.springerlink.com/physics-and-astronomy/>-Springer Link Date mardi 13 octobre 2009.

In an embodiment of the coherent XUV pulse generating system, the laser device comprises means for direct femtosecond amplification coupled with the harmonic generator device 20 including a gas-filled hollow core fiber. Indeed, as indicated in the document entitled “High harmonic generation (HHG) in a Kagome-type hollow-core photonic crystal fiber (HC-PCF)* Heckl, O. H.; Baer, C. R. E.; Krankel, C.; Marchese, S. V.; Schapper, F.; Holler, M.; Sudmeyer, T.; Robinson, J. S.; Tisch, J. W. G.; Couny, F.; Light, P.; Benabid, F.; Russell, P. S. J.; Keller, U.-Lasers and Electro-Optics 2009 and the European Quantum Electronics Conference. CLEO Europe—EQEC 2009. European Conference on Volume, Issue, 14-19 Jun. 2009 Page(s):1-1 Digital Object Identifier 10.1109/CLEOE-EQEC.2009.5192106, Hollow Core Fiber coupled with a conventional bulk laser device can produce harmonics with an energy of only 440 nJ. Moreover, a fiber based laser comprising means for direct femtosecond amplification can produce ultra brief impulsion with an energy of 1000 nJ, as explained in the document “Jan. 15, 2008/Vol. 33, No. 2/OPTICS LETTERS 107 Stretcher-free high energy nonlinear amplification of femtosecond pulses in rod-type fibers Y. Zaouter,1,3,* D. N. Papadopoulos,2 M. Hanna,2 J. Boullet,1 L. Huang,1 C. Aguergaray,1 F. Druon,2 E. Mottay,3 P. Georges,2 and E. Cormier1”.

The applicative chamber 30, as illustrated on FIG. 3, is coupled to the interaction chamber 20 to receive the XUV radiation beam, comprises an XUV spectrometer. The XUV spectrometer includes an entrance slit 230, a XUV reflection grating 240 with a grating having a density of 600 lines per mm, and a position sensitive detector 250 that is used to characterize the diffracted beam. This detector 250 is, for example, a dual multichannel plate (MCP) detector coupled to a phosphor screen which is imaged on a 16 bits cooled CCD camera. The XUV spectrometer can further comprise a motorization for rotating the grating 240, to tune the incidence angle of the XUV beam radiation. Hence, the detector 250 can cover a range of wavelengths from 30 nm to 100 nm. The detector 250 can observe clearly well defined high order harmonics, despite the limited transmission imposed by the entrance slit and the low diffraction efficiency of the grating that leads to an overall efficiency of the XUV spectrometer smaller than 1/1000. Both the gas/laser interaction geometry and the XUV spectrometer design are significantly optimized to handle a very high photon flux.

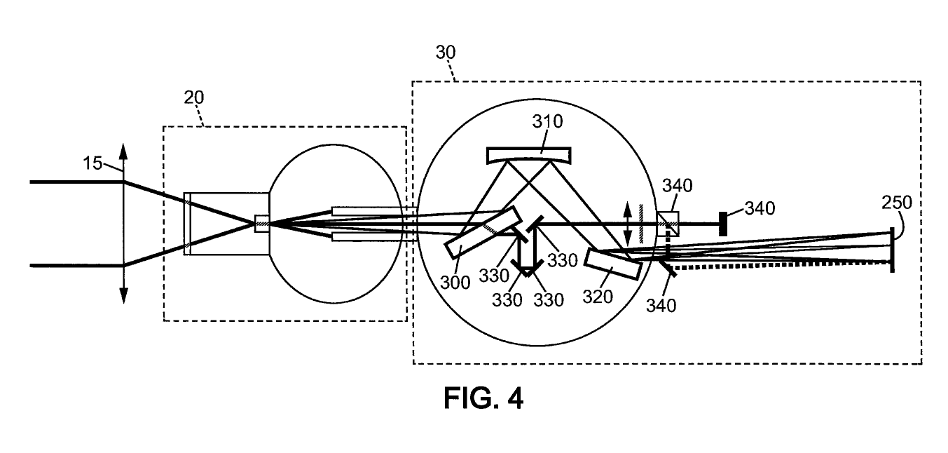

Referring now to FIG. 4, there is shown therein a schematic view of an embodiment of the applicative device 30 comprising an XUV spectrometer and a beam transport. In this embodiment, the XUV radiation beam is reflected by a glass plate 300. The glass plate 300 is a coated plate disposed relatively to the XUV radiation beam to form an angle close close to grazing incidence angle. The

XUV radiation beam is then split into an IR fundamental beam and a XUV beam, and can be controlled independently. The fundamental beam is transmitted trough the glass plate 300. The XUV beam is then refocused by a toroidal mirror 310. The re-focused XUV beam is then dispersed by a grating 320 if spectral selection is necessary or reflected by a second glass plate replacing the grating 320 if high temporal resolution is necessary. The IR beam, transmitted by the glass plate 300 can then be controlled in terms of intensity or focusing geometry, and delayed as compared to the XUV beam, by delaying means 330. Then the IR beam can be refocused at the same place as the re-focused XUV beam by IR re-focusing means 340 to allow IR-XUV experiments with possible temporal resolution.

The invention can be applied to many fields. It can be applied to ultra-high repetition rate probe systems, for example for chemistry or for atomic physics (“femtochemistry”). The present invention can be applied also in industry, for example for assisted laser ablation, or micro-machining (thanks to an association between infrared and XUV radiations). The present invention can be also applied in nanoscale characterisation and/or metrology. More particularly, an advantageous application of the present invention can be ultrahigh rate nanolithography, and also photo-excitation (for cosmetic applications for example).

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa. When data is being referred to as audiovisual data, it can represent audio only, video only or still pictures only or a combination thereof, unless specifically indicated otherwise in the description of the embodiments.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

A person skilled in the art will readily appreciate that various parameters disclosed in the description may be modified and that various embodiments disclosed and/or claimed may be combined without departing from the scope of the invention.

It is stipulated that the reference signs in the claims do not limit the scope of the claims, but are merely inserted to enhance the legibility of the claims.

1. A system for generating UV-XUV coherent pulses, comprising:
a fiber laser device adapted to produce a laser beam comprising pulses;
an harmonic generator device comprising an interaction medium;
the harmonic generator device and the fiber laser device being coupled so that, the laser beam hits the interaction medium with a power of at least 10¹³ W·cm², so as to generate said UV-XUV pulses.

2. The system according to claim 1, wherein the frequency of the pulses produced by the fiber laser device is configurable to adjust the rate of production of UV-XUV coherent pulses from 50 kHz to a few MHz.

3. The system according to claim 1, wherein said fiber laser device comprises means for chirp pulse amplification.

4. The system according to claim 1, wherein said fiber laser device comprises means for direct femtosecond amplification.

5. The system according to claim 1, wherein the interaction between the interaction medium and the laser beam generates the XUV pulses at high order harmonic frequencies.

6. The system according to claim 1, wherein the fiber laser device comprises rod-type fibres.

7. The system according to claim 1, wherein the fiber laser device comprises Yb-doped large mode area fibers.

8. The system according to claim 1, wherein the fiber laser device comprises Eb-doped large mode area fibers.

9. The system according to claim 1, wherein the fiber laser device comprises Tu-doped large mode area fibers.

10. The system according to claim 1, wherein the interaction medium comprises gas.

11. The system according to claim 10, wherein the interaction medium comprises an inert gas.

12. The system according to claim 1, wherein the interaction medium comprises a liquid target or a solid target.

13. The system according to claim 10, wherein the harmonic generator device comprises means adapted to confine the gas and to guide the laser beam, so that the gas and the laser beam interact.

14. The system according to claim 10, wherein the harmonic generator device comprises a cell comprising the gas in which an input hole and an output hole are drilled by the laser beam, so that the gas and the laser beam interact.

15. The system according to claim 10, wherein the harmonic generator device comprises a gas-filled hollow core fiber, arranged so that the gas and the laser beam interact.

16. The system according to claim 1, further comprising an XUV spectrophotometer coupled to receive the UV-XUV coherent pulses.
